(19) United States
(12) Patent Application Publication
(10) Pub. No.: US 2017/0372426 A1
(43) Pub. Date: Dec. 28, 2017

(54) Systems and Methods for Tracking Defined Contribution Benefit Plan Performance

(71) Applicant: Gregory Hankins, New York, NY (US)

(72) Inventor: Gregory Hankins, New York, NY (US)

(21) Appl. No.: 15/194,553

(22) Filed: Jun. 27, 2016

(51) Int. Cl. G06Q 40/06; G06Q 10/10

(52) U.S. Cl. CPC G06Q 40/06; G06Q 10/1057

(57) ABSTRACT

Systems and methods for tracking defined contribution benefit plan performance. User information relating to a defined benefit contribution plan is received over a network by a computing device. The user information comprises at least one fund and a plurality of performance thresholds relating to the fund. Each of the plurality of performance thresholds is associated with a respective alert. Performance data relating to the at least one fund is retrieved, over the network by the computing device. The performance data relating to the fund is compared by the computing device to the plurality of performance thresholds relating to the fund. In response to the performance data meeting one of the plurality of performance thresholds, the alert related to the respective performance threshold is generated and transmitted, over the network, to at least one mobile device associated with the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD

At least some embodiments disclosed herein relate, in general, to defined contribution benefit plans and more specifically to tracking the performance of such plans.

### BACKGROUND

There are more than 3.6 million small to midsize businesses whose employees may be enrolled in a defined contribution benefit plans, such as 401(k) plans. Oftentimes account holders do not receive advice or assistance and the only time they are aware of when funds in their account are losing money is when they received a quarterly statements. This can be especially problematical when the markets are volatile, such as in 2008 when many people lost much of their retirement savings invested in 401(k) plans.

### SUMMARY

User information relating to a defined benefit contribution plan is received over a network by a computing device. The user information comprises at least one fund and a plurality of performance thresholds relating to the fund. Each of the plurality of performance thresholds is associated with a respective alert

Performance data relating to the at least one fund is retrieved, over the network by the computing device. The performance data relating to the fund is compared by the computing device to the plurality of performance thresholds relating to the fund.

In response to the performance data meeting one of the plurality of performance thresholds, the alert related to the respective performance threshold is generated and transmitted, over the network, to at least one mobile device associated with the user.

Thus, a user (i.e. account holder) is alerted to poor performance by a fund, generally in less than 24 hours.

### BRIEF DESCRIPTION OF THE DRAWINGS

The embodiments are illustrated by way of example and not limitation in the figures of the accompanying drawings in which like references indicate similar elements.

FIG. 1 Shows an embodiment of user interface provided on a smart phone for receiving alerts and tracking 401(k) account performance in accordance with the present disclosure.

FIG. 2 Is an illustrative embodiment of system for tracking 401(k) account performance in accordance with the present disclosure.

FIG. 3-5 Illustrates an embodiment of a process for tracking 401(k) account performance in accordance with the present disclosure.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” or “computing device” should be understood to refer to a service point which provides processing, database, and communication facilities. By way of example, and not limitation, the term “server” or “computing device” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure a computer-readable medium stores computer data, which data can include computer program code that is executable by a computer, in machine readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory, or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

The present disclosure is directed to systems and methods to help account holders track their 401(k) mutual fund and stock options performance by a simple dashboard. In an embodiment, the systems and methods of the present disclosure enable the user to set performance benchmarks and receive alerts sent to their smart phones when the benchmarks are close to or have reached their limits.

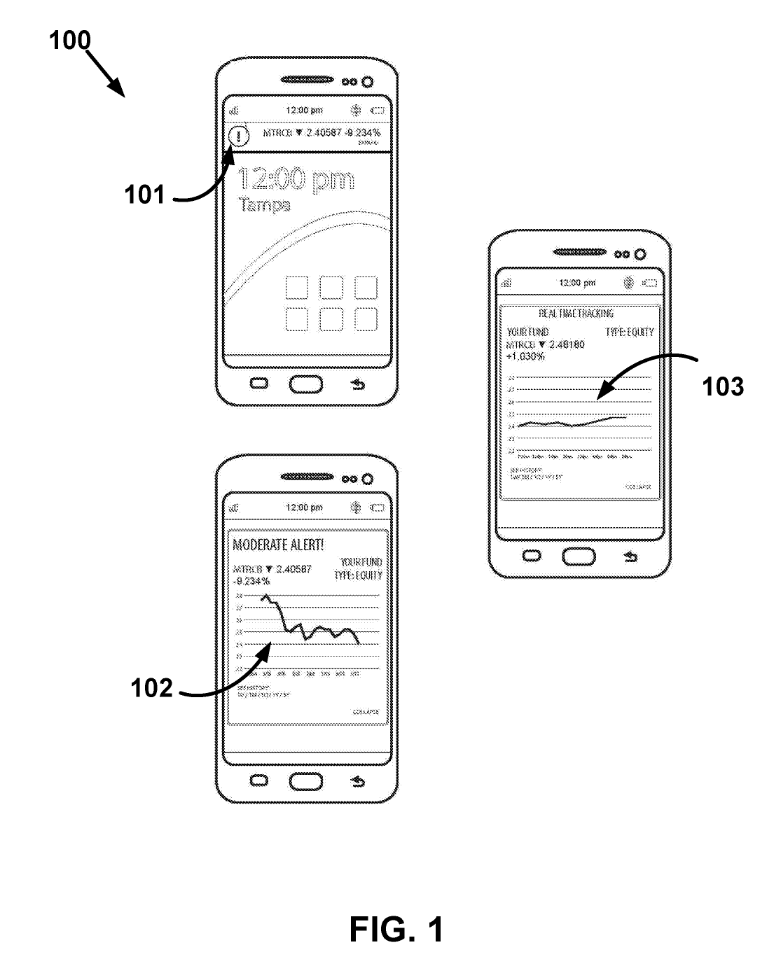

Referring first to FIG. 1, in an embodiment the primary user interface for an account holder is a graphical user interface provided by a mobile app 100. In an embodiment, when an alert condition is raised regarding an account holders account, the mobile app displays a pop-up alert 101. In an alternative embodiment, the account holder can receive an alert via email (not shown).

In an embodiment, using the app 100, the account holder is able to display an expanded or dashboard view of the alert 102. In an embodiment, the dashboard view of the alert 102 displays a chart showing the performance of a specific fund as a line graph. In various other embodiments, the dashboard view of the alert 102 can display fund performance in any suitable form such as, for example, a table showing the value of the fund at specific dates. In an embodiment, using the app 100, the account holder is able to display the realtime performance of a fund 103 at any point in time, and set benchmarks.

In various embodiments, the app 100, is implemented using any suitable programming language now known or later to be developed in the art. In an embodiment, the app 100 can be implemented to be able to run on any suitable platform, for example, an iPhone, an android phone, a tablet, a laptop, or a PC, or any other suitable platform now known or later to be developed in the art.

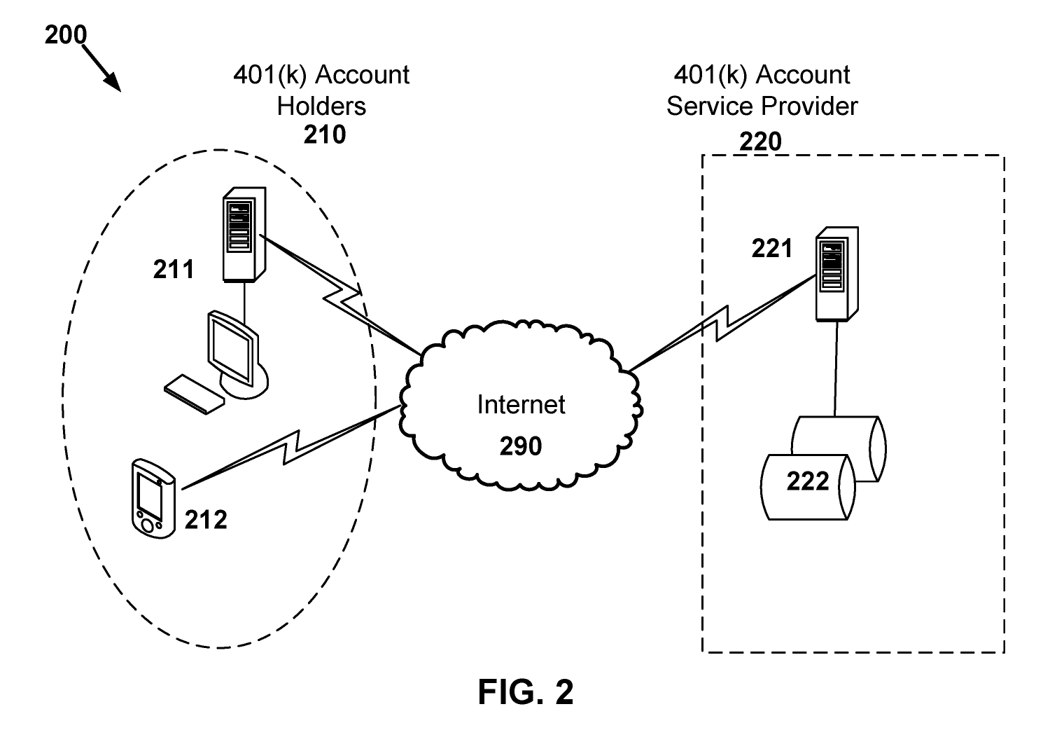

FIG. 2 illustrates an embodiment of an overall system 200 for providing alerts and fund performance information to 401(k) account holders 210.

A group of 401(k) account holders 210 hold 401(k) accounts, each account comprising one or more funds, such as mutual funds. The accounts are serviced by an 401(k) account service provider 200. The account holders 210 interact with the account service provider using user devices such as PCs 211 and smartphones 212 via the Internet 290.

The account service providers 220 have one or more servers 221 and databases 222 that provide various services to account holders 210. Such services comprise, as discussed above and below, maintaining account holder profiles, tracking fund performance, both in real-time and at end of day, and sending alerts to subscribers when fund performance falls below predetermined thresholds.

In an embodiment, the system is software-based PHP and MySQL for the web and web-based app for mobile.

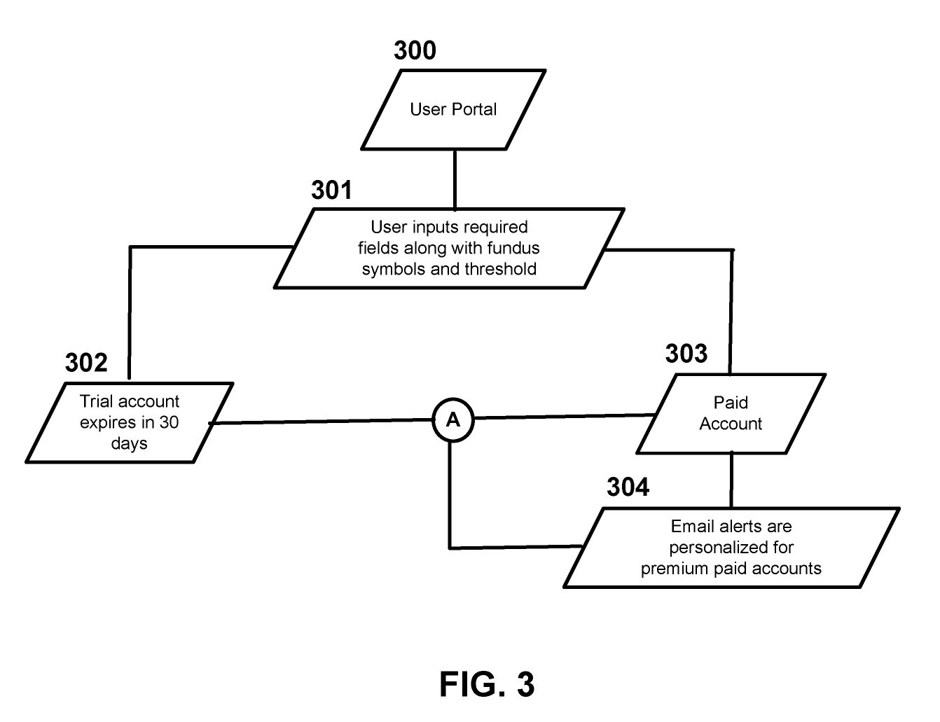

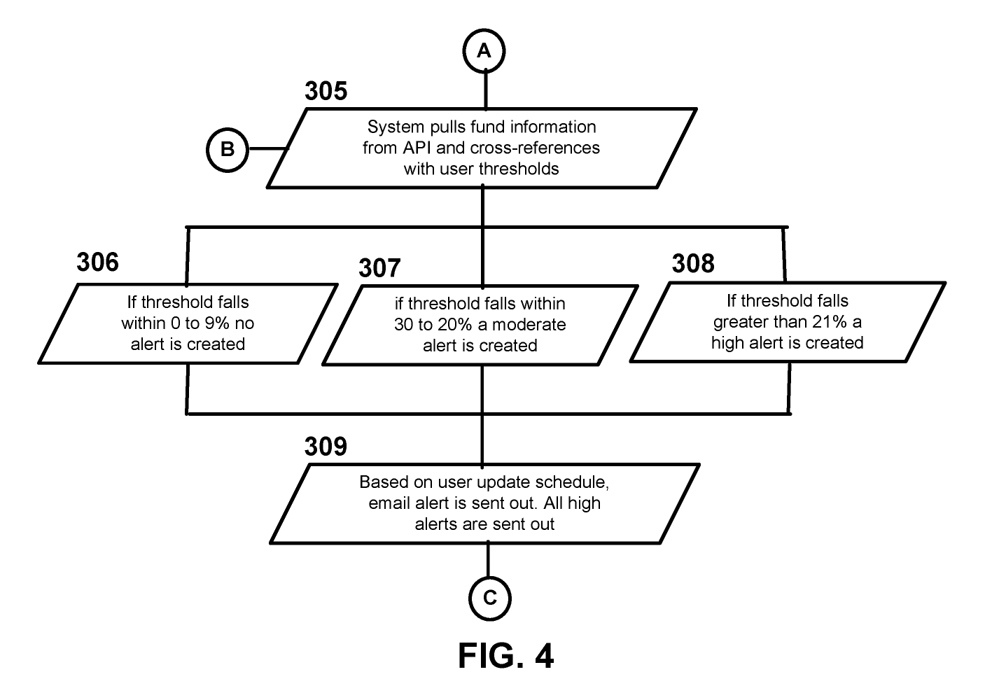

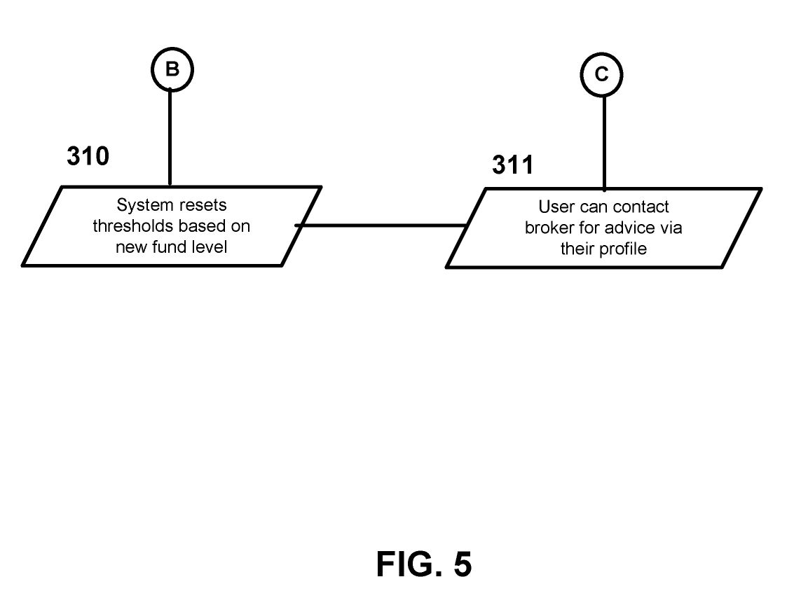

FIG. 3-5 Illustrates an embodiment of a 300 process for tracking 401(k) account performance in accordance with the present disclosure.

In an embodiment, an account holder initially interacts with the system via a user portal 300. The account holder, hereinafter “the user” first interacts with the system via a web-based (e.g. browser based) User Portal. Through the portal 300 the user inputs 310 required fields (e.g. profile fields) along with symbols for funds the user wishes to track and alert thresholds.

In an embodiment, a trial (i.e. free) account expires in 30 days 302 (or some other limited period.) In the case of a paid account 303, email alerts are personalized 304 for premium paid accounts.

In an embodiment, the system pulls fund information 305 from an API interface to a third party data source, in some embodiments, real-time or near time, in other embodiments at end or day, or potentially both. The fund information is then cross-referenced with user thresholds and if the change in a fund's value falls within certain thresholds alterts are generated.

An exemplary set of thresholds could be

0 to 9% no alert is created 306

10 to 20% a moderate alert is created 307

Greater than 21% a high alert is created 308

Based on user update schedule, email alerts 309 are sent out. All high alerts are sent out. System resets thresholds based on new fund level 310. Users can contact brokers for advice via their profile.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1. A method comprising:
receiving, over a network, by a computing device, user information relating to a defined benefit contribution plan, the user information comprising at least one fund and a plurality of performance thresholds relating to the at least one fund, each of the plurality of performance thresholds being associated with a respective alert;
retrieving, over the network, by the computing device, performance data relating to the at least one fund;
comparing, by the computing device, the performance data relating to the at least one fund to the plurality of performance thresholds relating to the at least one fund;
responsive to the performance data meeting one of the plurality of performance thresholds, generating the alert related to the respective performance threshold; and
transmitting, over the network, by the computing device, the alert related to the respective performance threshold to at least one mobile device associated with the user.

2. The method of claim 1 wherein each of the plurality of performance thresholds relating to the at least one fund comprises a lower and an upper bound, wherein if the performance of the at least one fund falls within the lower and the upper bound, the performance threshold is met.

3. The method of claim 2 wherein the performance of the at least one fund is measured as an absolute value of the fund compared to a targeted baseline.

4. The method of claim 2 wherein the performance of the at least one fund is measured as a percentage change in the value of the fund over time.

5. The method of claim 1 wherein the alert related to the respective performance threshold is a pop-up alert on the at least one mobile device associated with the user.

6. The method of claim 5 wherein the user is enabled to display an expanded dashboard view of the alert.

7. The method of claim 6 wherein the expanded dashboard view of the alert displays a chart showing the performance of a specific fund as a line graph.

8. The method of claim 6 wherein the expanded dashboard view of the alert displays a chart showing the performance of a specific fund as a table showing the value of the fund at specific dates.

9. The method of claim 1 wherein the alert related to the respective performance threshold is email alert on the at least one mobile device associated with the user.

10. The method of claim 1 wherein the network is the Internet.

11. The method of claim 1 wherein the at least one mobile device is selected from the list: cell phone, smart phone, tablet computer, and laptop computer.

12. A system comprising:
a first computing device configured to
receive, over a network, user information relating to a defined benefit contribution plan, the user information comprising at least one fund and a plurality of performance thresholds relating to the at least one fund, each of the plurality of performance thresholds being associated with a respective alert;
a second computing device configured to
retrieve, over the network, performance data relating to the at least one fund;
a third computing device configured to
comparing, the performance data relating to the at least one fund to the plurality of performance thresholds relating to the at least one fund;
responsive to the performance data meeting one of the plurality of performance thresholds, generating the alert related to the respective performance threshold;
a fourth computing device configured to
transmit, over the network, the alert related to the respective performance threshold to the user;
at least one mobile device associated with the user configured to receive the alert related to the respective performance threshold and to display the alert as a pop-up alert.

13. The system of claim 12 wherein each of the plurality of performance thresholds relating to the at least one fund comprises a lower and an upper bound, wherein if the performance of the at least one fund falls within the lower and the upper bound, the performance threshold is met.

14. The system of claim 13 wherein the performance of the at least one fund is measured as an absolute value of the fund compared to a targeted baseline.

15. The system of claim 13 wherein the performance of the at least one fund is measured as a percentage change in the value of the fund over time.

16. The system of claim 12 wherein the user is enabled to display an expanded dashboard view of the alert.

17. The system of claim 16 wherein the expanded dashboard view of the alert displays a chart showing the performance of a specific fund as a line graph.

18. The system of claim 16 wherein the expanded dashboard view of the alert displays a chart showing the performance of a specific fund as a table showing the value of the fund at specific dates.

19. A computer-readable medium encoding instructions for a method, the method comprising:
receiving, over a network, by a computing device, user information relating to a defined benefit contribution plan, the user information comprising at least one fund and a plurality of performance thresholds relating to the at least one fund, each of the plurality of performance thresholds being associated with a respective alert;
retrieving, over the network, by the computing device, performance data relating to the at least one fund;
comparing, by the computing device, the performance data relating to the at least one fund to the plurality of performance thresholds relating to the at least one fund;
responsive to the performance data meeting one of the plurality of performance thresholds, generating the alert related to the respective performance threshold; and
transmitting, over the network, by the computing device, the alert related to the respective performance threshold to at least one mobile device associated with the user.

20. The computer-readable medium encoding instructions for the method of claim 19 wherein each of the plurality of performance thresholds relating to the at least one fund comprises a lower and an upper bound, wherein if the performance of the at least one fund falls within the lower and the upper bound, the performance threshold is met.
